(19) United States
(12) Patent Application Publication
(10) Pub. No.: US 2004/0224143 A1
(43) Pub. Date: Nov. 11, 2004

(54) Metal-ceramic composite material

(76) Inventors: Nicole Neumann, Esslingen (DE); Martin Schlegi, Rudersberg (DE); Karl-Heinz Thiemann, Korb (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/478,804

(22) PCT Filed: Apr. 4, 2002
(86) PCT No.: PCT/EP02/03742

(30) Foreign Application Priority Data
May 26, 2001 (DE) 101 25 815.1

(51) Int. Cl. B32B 3/00

(52) U.S. Cl. 428/304.4; 428/314.2

(57) ABSTRACT

A metal-ceramic composite material has a ceramic matrix and at least one metallic phase, which are intermingled with one another, together forming a virtually completely dense body, and which are in contact with one another at boundary surfaces. The boundary surfaces are of acicular form, and the metallic phases and the ceramic matrix intermesh by means of the acicular boundary surfaces. Furthermore, tubular passages, which are filled by at least one metallic phase, pass through the composite material.

This application claim the priority of German Patent document 101 25 815.1, filed May 26, 2001, (PCT International No. PCT/EP02/03742, filed Apr. 4, 2002), the disclosure of which is expressly incorporated by reference herein.

### SUMMARY OF THE INVENTION

The invention relates to a metal-ceramic composite material that has a ceramic matrix and at least one metallic phase which are intermingled with one another.

European Patent Document No. EP 739 668 A2 has disclosed a cylinder liner made from a metal-ceramic composite material. This cylinder liner is fabricated by producing a porous ceramic preform from a ceramic powder and ceramic fibers in a conventional way and then infiltrating this preform with a liquid metal. The cylinder liner formed in this way is then inserted into a casting mould as a core and then surrounded by cast liquid metal. The component which results is a cylinder casing which is locally reinforced by the composite material in the region of the liner.

The drawback of composite materials of this type is the microscopic bonding between the preform and the metallic phase. In the composite material, the ceramic preform forms what is known as the matrix of the composite material. Wetting between the surface of the matrix and the metallic phase (boundary surface) which is less than optimal means that theoretical strength of the materials is not achieved. Furthermore, composite materials of this type have brittle fracture characteristics in all volume directions, which is determined by the ceramic matrix and cannot be satisfactorily compensated for by the metallic phase.

A further drawback of composite materials of this type manifests itself in the form of a low thermal conductivity compared to metals. For applications in the internal combustion engine sector or the power electronics sector, this leads to a build-up of heat and therefore in many cases to components failing.

Accordingly, an object of the invention is to provide a metal-ceramic composite material which, compared to the prior art, has an improved bonding between a ceramic matrix and metallic phases and is distinguished by a higher ductility and thermal conductivity.

This and other objects and advantages are achieved by the metal-ceramic composite material according to the invention (composite material) which includes at least one metallic phase and a ceramic matrix. The composite material is formed by a ceramic preform being infiltrated with a liquid metal. A surface of the ceramic matrix has an acicular structure, in which the metal engages after infiltration and silicidation. This surface is referred to below as the boundary surface between the matrix and the metallic phase. This significantly increases the bonding of the ceramic matrix to the metallic phase, which has beneficial effects on the strength of the composite material.

In addition, the ceramic matrix is configured in such a way that it has tubular passages, which preferably run parallel to one another, passing through it. Therefore, the composite material has an additionally increased elongation at break perpendicular to the passages. Along the passages, tensile stresses or compressive stresses can likewise be compensated for by a higher elasticity. The risk of spontaneous and therefore catastrophic component failure is significantly reduced.

The passages are preferably arranged parallel to one another, with the deviation in their spatial direction generally amounting to no more than 15°, in particular no more than 1°. The passages run substantially in a straight line, although slight waviness is permitted. Helically arranged passages are conceivable and advantageous but are more complex to produce in terms of the process engineering required.

A further advantageous embodiment of the invention consists in a plurality of sets of passages running in different spatial directions, preferably perpendicular to one another. Although this reduces the volume of the matrix in favor of the metallic phase, which may slightly reduce the strength, the elongation at break at the composite material is increased. The wall thicknesses between the passages are preferably between 0.1 mm and 1 mm.

The passages preferably have a diameter of between 0.5 mm and 20 mm. It is in this range that the elastic behavior of the metal is best brought to bear. The thicknesses of the individual passages may differ.

The needles of the acicular structure at the boundary surface usually have a length of between 10 μm and 1000 μm. The particularly preferred needle length is between 20 μm and 300 μm. Shorter needles would not result in intermeshing, whereas longer needles would be more likely to break. The mean diameter of the needles is preferably between 0.1 μm and 100 μm.

The ceramic phase and the metallic phase are three-dimensionally linked together. Although the metallic phases in the passages are isolated, the matrix between the passages is porous and the metallic phase likewise penetrates through it. The ceramic matrix has a porosity of between 30% and 90%, preferably between 50% and 70%. These pores are virtually completely filled by the metallic phase.

In another embodiment, the ceramic preform preferably consists of mullite or silicates, which tend to form acicular structures (crystallites) at the surface, or alternatively crystallites of this type can be grown without great difficulty.

In yet another embodiment, the metals magnesium and aluminum or their alloys are particularly suitable for use for the composite material according to the invention. They have a low relative density, which is advantageous in particular when the composite material is used in lightweight structures. Furthermore, these metals can successfully be cast by the pressure die-casting process, which advantageously facilitates the infiltration of the porous ceramic.

In still another embodiment, a further expedient application of the composite material according to the invention is as a heat sink which is suitable for the cooling of power electronics. This heat sink has passages from a surface, on which electronic components are arranged, toward a cooling medium. These passages effect a high thermal conductivity and therefore rapid heat transfer from the surface to the cooling medium.

Advantageous exemplary embodiments of the invention are described below.

### BRIEF DESCRIPTION OF THE DRAWINGS

FIG. 1 shows a surface of a ceramic preform,

FIG. 2 diagrammatically depicts the microstructure of a composite material at a transition between a matrix and a passage,

FIG. 3 shows a diagrammatic, macroscopic illustration of a composite material with passages running parallel to one another,

FIG. 4 shows a diagrammatic macroscopic illustration of a composite material with sets of passages running parallel to one another in different directions, and

FIG. 5 shows a heat sink arrangement mounted with power electronics.

### DETAILED DESCRIPTION OF THE EMBODIMENTS

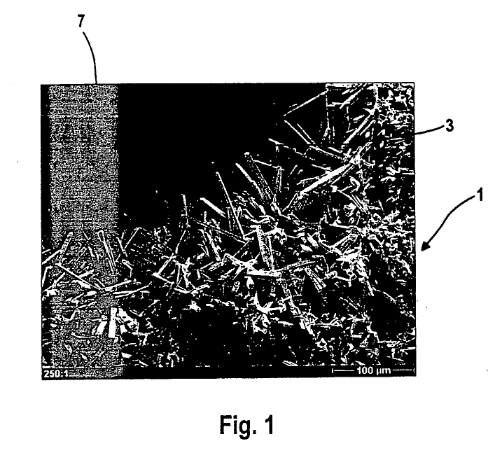

FIG. 1 shows a scanning electronic microscope image of a surface of a porous ceramic preform 1 on a scale of 1:250. The preform 1 is already formed in such a way that it comprises passages 7 and a ceramic matrix structure 5. The excerpt shown in FIG. 1 illustrates the transition between a passage 7 and the ceramic matrix structure 5. The surface of the matrix 5 has acicular crystallites 3 which continue into the volume of the matrix. In its volume, the matrix has additional material fractions in grain form, which are fixedly joined to the acicular crystallites 3 by sintering processes, which despite the extremely fine surface leads to a high stability of the matrix 5. The ceramic matrix illustrated in FIG. 1 consists of mullite.

To produce a composite material 11 according to the invention, the preform 1 is infiltrated with a liquid metal, preferably a castable alloy of aluminum (e.g. AlSi9Cu3) or of magnesium (e.g. AZ91). This infiltration can be carried out using capillary forces, provided that the ceramic material of the matrix 5 is wetted by the liquid metal. The infiltration of the preform 1 is usually carried out under pressure. This can be realized in the form of gas-pressure infiltration or by infiltration using the pressure die-casting or squeeze-casting process. In the latter two cases, the preform is introduced into a cavity of a corresponding casting die and supported. The die is closed and the liquid metal is forced into the die under pressure (between 20 MPa and 100 MPa). In the process, the cavity of the die and the pores of the preform are filled with liquid metal. After silicidation, the die is opened and the composite material 11 which has been formed in this way is removed.

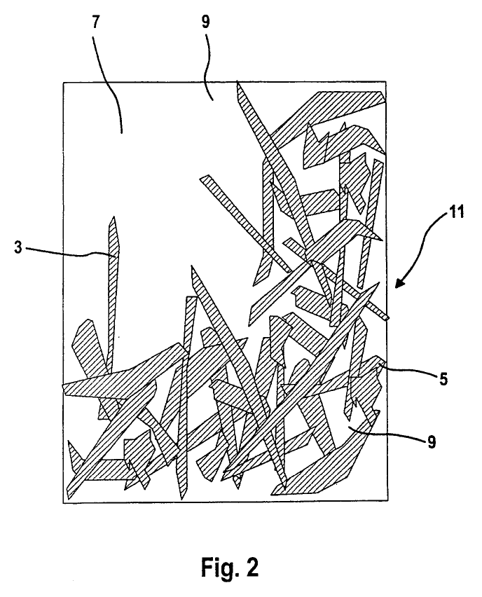

The microstructure of the composite material is diagrammatically depicted in FIG. 2, which also shows the transition between the matrix 5 and a passage 7. The needle structure at the boundary surface is retained after the infiltration and leads to intermeshing, so that the strength of the composite material 11 is increased. The passages 7 consist virtually entirely of the metallic phase 9. The matrix 5 has likewise been penetrated by the metallic phase 9. Both the matrix 5 and the metallic phase 9 are three-dimensionally linked together through the entire composite material 11.

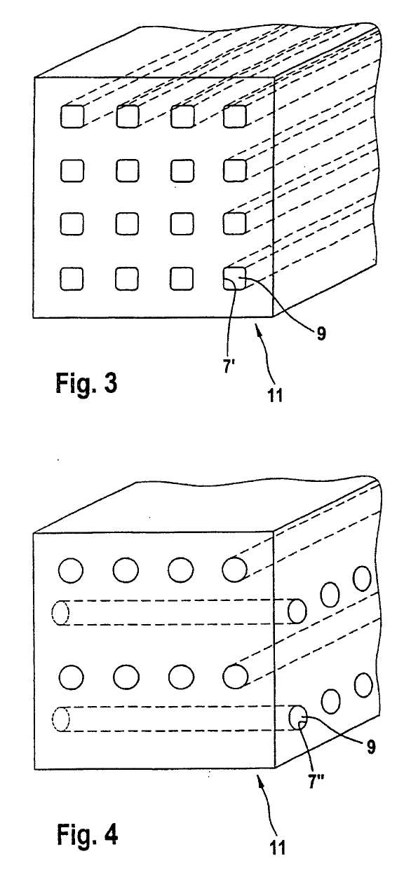

Macroscopic representations of the composite material 11 presented in FIG. 3 and FIG. 4 show arrangements of the passages 7 in the composite material. In FIG. 3, the passages 7′ are arranged parallel to one another and run unidirectionally, in a single direction. Similarly, in FIG. 4 parallel sets of passages 7″ in each case run perpendicular to one another. The cross section of the passages 7 may be configured in various forms. Rounded rectangular passages 7′ or round passages 7″ are expedient, but oval cross sections are also conceivable.

The profile of the directions of the passages is dependent on the demands of a component which is to be formed. In FIG. 4, the passages 7″ do not touch one another, but it is conceivable for materials to penetrate between passages 7 running in different directions. Also, a composite material with passages 7 or sets of passages 7 which run in more than two spatial directions may be advantageous. The angle between the spatial directions can be selected as desired.

It is particularly advantageous for the composite material according to the invention to be used as a reinforcement in components which are subject to high mechanical, thermal and/or frictional loads, in particular light metal components. In these applications, local reinforcement of the components is expedient, with the pressure die-casting or squeeze-casting process being particularly suitable for production of the composite material 11. The insertion of the preform 1 into the casting die allows regions of the component which are subject to particularly high loads to be deliberately filled with the preform.

Components which are suitable for reinforcement with the composite material according to the invention include cylinder crankcases, bearing seats for crankshafts, bearings for transmission cases, other bearings or structural parts, in particular of castings. To a limited extent, it is also possible to reinforce cylinder heads, which are generally produced using the sand-casting process. In this case, the finished composite material is placed into a casting mold and is surrounded by the liquid casting metal without using an external pressure. Similarly, it is possible for structures of the composite material to be integrated in structural components which are not cast, but rather comprise, for example, forged parts and/or sheet-metal parts and/or combinations of different types of materials.

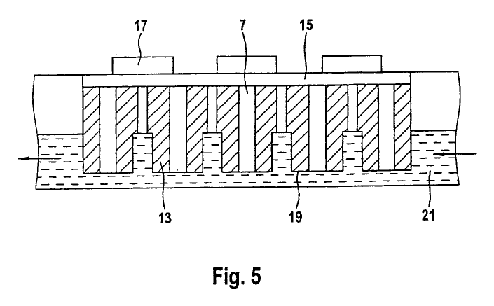

A further expedient application for the composite material according to the invention is a heat sink arrangement as shown in FIG. 5. The heat sink 13, which consists of the composite material according to the invention, is provided with an electrically insulating layer 15 at a surface. The layer 15 preferably consists of aluminum nitride or silicon carbide, which are materials with a high thermal conductivity. Power electronics components 17, the operation of which generates a large amount of thermal energy, are mounted on the insulating layer 15.

In an embodiment, to improve dissipation of the thermal energy which is produced, the heat sink according to the invention is configured in such a way that passages 7 which are filled with metallic phase run from the insulating layer 15 toward a cooling medium 21. The passages 7 are preferably filled with aluminum or an aluminum alloy or other metals with a high thermal conductivity (e.g. copper). The cooling medium 21 generally consists of water which is provided with corrosion-preventing additives, and it flows through pins 19 of the heat sink 13 in the direction indicated by the arrows. The pins 19 serve to increase the surface area via which the thermal energy is dissipated to the cooling medium. The passages 7 accelerate the heat transfer from the insulating layer 15 to the cooling medium 21, since the metallic phase 9 has a higher thermal conductivity than the remaining regions of the composite material.

A further advantage of the heat sink 13 according to the invention compared with a conventional heat sink made from copper or pure aluminum is its relatively low expansion coefficient parallel to the insulating layer 15. This minimizes thermal stresses between the heat sink 13 and the insulating layer 15 and ultimately increases the service life of the component.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-9. (Cancelled)

10. A metal-ceramic composite material comprising:
a ceramic matrix; and
at least one metallic phase, the at least one metallic phase and the ceramic matrix being in contact with one another at least one boundary surface; wherein
the metallic phase and ceramic matrix are intermingled with one another and together form a virtually completely dense body;
the at least one boundary surface is acicular in form;
the at least one metallic phase and the ceramic matrix intermesh by means of the at least one acicular boundary surface, and
the composite material has tubular passages passing through it which are filled by the at least one metallic phase.

11. The metal-ceramic composite material of claim 10, wherein the tubular passages are oriented substantially parallel to one another.

12. The metal-ceramic composite material of claim 10, wherein sets of parallel tubular passages run in at least one spatial direction.

13. The metal-ceramic composite material of claim 10, wherein the tubular passages have a diameter of between 0.5 mm and 20 mm.

14. The metal-ceramic composite material of claim 10, wherein the length of needles of the at least one acicular boundary surface is between 10 μm and 1 000 μm.

15. The metal-ceramic composite material of claim 10, wherein the at least one metallic phase and the ceramic matrix are three-dimensionally linked together.

16. The metal-ceramic composite material of claim 10, wherein the ceramic matrix is selected from the group consisting of mullite or silicates.

17. The metal-ceramic composite material of claim 10, wherein the at least one metallic phase comprises aluminum, magnesium, or alloys of these metals.

18. A heat sink comprising a composite material according to claim 10, wherein the heat sink includes passages that run from a surface which is acted on by thermal energy toward a cooling medium.

19. A heat sink according to claim 18, wherein the heat sink is a power electronics heat sink.
